(19) United States
(12) Patent Application Publication
(10) Pub. No.: US 2018/0046766 A1
(43) Pub. Date: Feb. 15, 2018

(54) SYSTEM FOR RAPID TRACKING OF GENETIC AND BIOMEDICAL INFORMATION USING A DISTRIBUTED CRYPTOGRAPHIC HASH LEDGER

(71) Applicant: Novus Paradigm Technologies Corporation, Vancouver (CA)

(72) Inventors: Andrew DEONARINE, Angus (CA); Railton FRITH, Little Kimble (GB); Nicolas NEWTON, Vancouver (CA); Olivier Francois Roussy NEWTON, Vancouver (CA)

(21) Appl. No.: 15/633,627

(22) Filed: Jun. 26, 2017

Related U.S. Application Data
(60) Provisional application No. 62/355,229, filed on Jun. 27, 2016.

(51) Int. Cl. G06F 19/00; H04L 9/06

(52) U.S. Cl. CPC G06F 19/326; H04L 9/0643

(57) ABSTRACT

A hardware device and/or software system providing a method of timestamping, indexing, securing, and transmitting biomedical information (such as DNA sequences, patient chart notes, lab tests, diagnoses, radiology results, and similar information) along with metadata associated with this information (such as date, time, author); using a public or private distributed cryptographic hash ledger method to create a stable, tamperproof index that permits auditing and tracing information transit over an or several electronic networks/transmission methods; optionally compressing and/or encrypting information using secure encryption methods such as quantum-safe/quantum-secure/quantum-resilient methods that secures the key and the payload independently, and then storing the information on a local electronic device or computer, such as a DNA sequencing machine, or transmitting the information over an electronic network or storing it on a removable device.

### CROSS-REFERENCE TO RELATED APPLICATIONS

This patent application claims priority from, and incorporates by reference, the entire disclosure of U.S. Provisional Patent Application No. 62/355,229, filed Jun. 27, 2016.

### FIELD OF THE INVENTION

The present invention relates to systems and methods for facilitating the secure exchange and tracking of biomedical information using a distributed cryptographic hash ledger. More specifically, the biomedical information may be in the nature of that associated with disease diagnosis and transmission.

### BACKGROUND

Disease outbreaks and transmission, such as epidemics and pandemics, involve a disease or disorder being transmitted from one organism (such as a human, other mammal, etc.) to another. Often, diseases will be identified using laboratory information, such as the concentration of a molecule in blood, a DNA sequence, a clinical note in a patient chart, etc. During an outbreak, epidemic, or pandemic, transmitting, sharing and processing this information can be important to efforts to monitor and contain the disease. Hence, tracking this information in a reliable fashion requires a system which can permit and facilitate recording, tracking and sharing (publicly and securely) of such information, furthermore, the information must be anonymous or identifiable (whichever is appropriate under the circumstances), auditable, and reproducible. Increasingly, molecular sequencing information such as that produced using DNA/RNA sequencing (DNA-Seq, RNA-Seq, or other similar sequencing (Ribo-Seq, X-Seq, etc.)) analysis is also involved in identifying and tracking disease outbreaks as well.

For purposes of illustration, the diseases in question may include those involving conventional pathogens, such as HIV, influenza, and tuberculosis, as well as outbreaks, epidemics, and pandemics associated with more novel pathogens, such as the Middle Eastern Respiratory Virus (MERV) and the Zika virus.

Currently there is no satisfactory way to track information associated with disease diagnosis or disease transmission in a decentralized way which allows for such information to be traced, audited, anonymized (when appropriate), encrypted, and then safely and securely transmitted/distributed, although it can be seen that it would be advantageous to be able to do so. Such information could then be received by another device, where it can be decrypted, stored, and used in other medical information systems for use by health care workers and others.

A distributed cryptographic hashing index (such as blockchain) has historically been used to track electronic transactions, such as those that occur with Bitcoin. The blockchain provides a distributed ledger which can be used to store complex, distributed information for transactions over the Internet. Accordingly, it is contemplated that such distributed cryptographic hashing index methodologies may be adapted for use in dealing with biomedical information of the sort described above.

Implementing such a system using a distributed cryptographic hashing index could help with managing information and clinical cases during scenarios such as an epidemic or pandemic, when performing this process rapidly is essential. This can help with storing, tracking, and transmitting information pertaining to key medical activities during an outbreak, such as laboratory diagnosis, immunization, administration of post-exposure prophylaxis, contact tracking, and other medical tasks. Using this approach is of particular importance in time-sensitive situations such as outbreaks, epidemics and pandemics since accuracy, timeliness, and fidelity of such data is critical, and often outbreaks will take place in distributed locations, making distributed ledgers important.

### BRIEF SUMMARY OF THE PRESENT INVENTION

The embodiments of the present invention relate to a distributed cryptographic hashing indexing (such as blockchain) device, system and method which facilitate the public or private exchange of biomedical information (for example, such as DNA sequence information and ontological data), either anonymously or otherwise, without concerns for security, privacy violations, or information being released to incorrect destinations (i.e. other than hospitals, appropriate medical institutions, laboratories, etc.). It can be used with medical software, diagnostic equipment, DNA sequencing machines, and similar devices for tracking, encoding, anonymizing, transmitting, and securing medical information which can occur during a disease transmission event in an outbreak, or medical events involved in managing an outbreak (immunization, post-exposure prophylaxis, contact tracing, etc.).

The present invention comprises a system and computer-implemented method for tracking medical information about human beings and other organisms using a distributed cryptographic hashing index. In accordance with an aspect of the present invention, the system is configured to process raw medical data (such as DNA sequence data, enzyme activity levels, molecular concentrations, clinical notes from physicians, and other similar pieces of information), optionally encrypts the data, create associated metadata, and then calculate a blockchain for tracking this medical information. This allows the information to be more securely stored and, when required, anonymously exchanged across public computer networks such as the Internet. This system and method is also useful for “de-identifying” or “anonymizing” data, which needs to be done when cross-referencing information from multiple databases, by incorporating identifying information into a cryptographic hash ledger. Since the information is not readily identifiable or extractable from the cryptographic hash ledger (without expending considerable resources such as those employed to mine Bitcoin) or impossible, it is much easier to ensure that data is not lost, and that it is tamperproof, secure and not identifiable.

Disclosed herein is a system, comprising a computer program product comprising a computer readable memory storing computer executable instructions thereon that, when executed by a computer, perform the computer-implemented method described herein. For example, the computer readable memory may reside on laboratory machinery or in an electronic medical records system, or on a custom programmable chip or customized computer system. The hardware/software or software only implementations can be connected to laboratory equipment to automate the process of blockchain generation and information transmission without human intervention. Such a system can facilitate the transmission and integration of information. It is contemplated that such a system could be particularly useful when linked to a DNA-Seq/RNA-Seq/X-Seq sequencing machine, allowing for immediate, automated reporting of data.

The system can be customized to use different encryption algorithms, including classical encryption methods, standard methods such as Data Encryption Standard (DES) and Advanced Encryption Standard (AES), as well as more modern methods like tamperproof, quantum-safe, and/or quantum-secure methods such as quantum key distribution (i.e. unbreakable by any number of any size quantum computers working for an infinite amount of time) or quantum-resilient methods (i.e., the method can be scaled to prevent attacks by the number of available quantum computers), using different pieces of metadata (which can include manually entered information such as comments, permissions for which servers/computers can receive data, and similar information, as well as auto-generated fields like date, time location, and others) to generate the distributed cryptographic hash ledger (such as a blockchain), and using different types of raw data. The system may also be configured with default settings to generate distributed cryptographic hash ledger information to facilitate the tracking of medical information.

### BRIEF DESCRIPTION OF THE DRAWINGS

FIG. 1 is a block diagram illustrating the layer model involved in generating a distributed cryptographic hash based ledger for medical information.

FIG. 2 illustrates the steps involved in generating a distributed cryptographic hash ledger using raw data and metadata for individual sequence information and collections of medical information.

FIG. 3 illustrates the steps involved in generating a distributed cryptographic hash ledger using raw data and metadata for single pieces and collections (computer files) of medical information.

FIG. 4 illustrates a method for generating distributed cryptographic hash ledgers using metadata and parsed data to produce fully indexed data.

FIG. 5 illustrates a method for encoding information in a distributed cryptographic hash ledger.

FIG. 6 illustrates the methods described in FIG. 4 and FIG. 5 outlined in pseudo-code.

FIG. 7 Illustrates the steps involved in receiving the data after transmission, and then processing it for use, which can involve decryption, parsing and storage, and use in other software or devices.

FIG. 8 illustrates the method by which biomedical data, metadata, and distributed cryptographic hash ledger indices can be transmitted to other devices securely.

FIG. 9 is a block diagram of a programmable processor suitable for applying the described process and for performing the functions involved.

### DETAILED DESCRIPTION OF THE INVENTION

The present invention will now be described more fully hereinafter with reference to the accompanying drawing(s), which form a part hereof, and which show, by way of illustration, exemplary embodiments by which the invention may be practiced. The invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

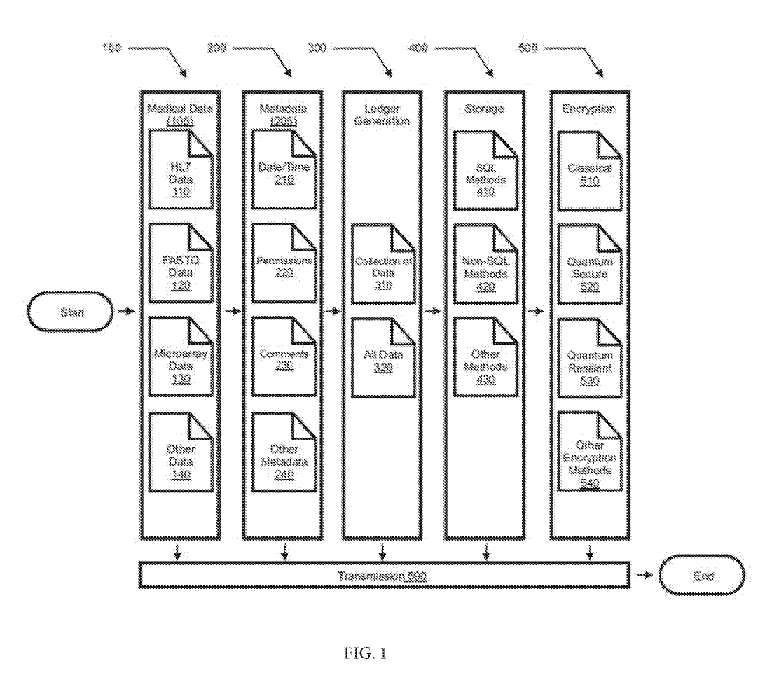

FIG. 1 is a block diagram illustrating the steps involved in generating a distributed cryptographic hash-based ledger for medical information, in accordance with an aspect of the present invention. There are various types of medical information that may be generated for a patient during certain medical activities such as, for example, a typical visit to a doctor's office, when performing a medical test at a laboratory, or when being immunized by a public health nurse, etc. During an outbreak or epidemic/pandemic, other additional activities may include receiving a vaccination, post-exposure prophylaxis administration, contact tracing of people who may have been infected by diseased cases, etc. In the data layer (100), medical data (105) produced by these different medically related activities is produced from the patient encounter by a health care worker. The medical data (105) may include medical tests, chart notes, medical imaging, data produced by laboratory equipment, or other media which can be electronically stored and transmitted as HL7 (Health Level 7) data (110), or DNA sequence data from DNA sequencing machines in FASTQ or similar formats (120), microarray data (130), digital images, sound or video, and other electronic data formats such as TXT (TeXT) and XML (eXtensible Markup Language) (140).

The metadata layer (200) comprises various metadata (205). The metadata 205 can be automatically produced or generated by the system (such as date, time, author, and similar fields (210)) or manually entered by a user, including permissions (220) which restrict which computers or devices can accept the data, comments associated with the data (230), or other metadata (240). Excluding identification information can permit the anonymous transmission of data when necessary.

In the distributed cryptographic hash ledger layer (300), a distributed cryptographic hash ledger is generated using the medical data and the metadata. Distributed cryptographic hash ledgers can be calculated for each individual data element (310) (such as for each DNA sequence in a FASTQ file) or for the entire set of data (320) (such as a HL7 transaction, FASTQ file, text file, or similar entity).

The storage layer (400) consists of a way to store information, which can be in an SQL database (410), a NOSQL database (420) (e.g. a graph database or triple store), or other storage methods, which can consist of proprietary binary storage/file formats, temporary storage in volatile memory such as random access memory, etc. (430). This information can then be easily retrieved for further processing, transmission or use.

In the encryption layer (500), data can then be optionally encrypted using different optional encryption methods or a combination of encryption methods, including classical methods (510), quantum-safe/quantum-secure methods (520), quantum-resilient methods (530), Advanced Encryption Standard (AES) encryption, or other methods (540). The information can then be transmitted securely (step 590).

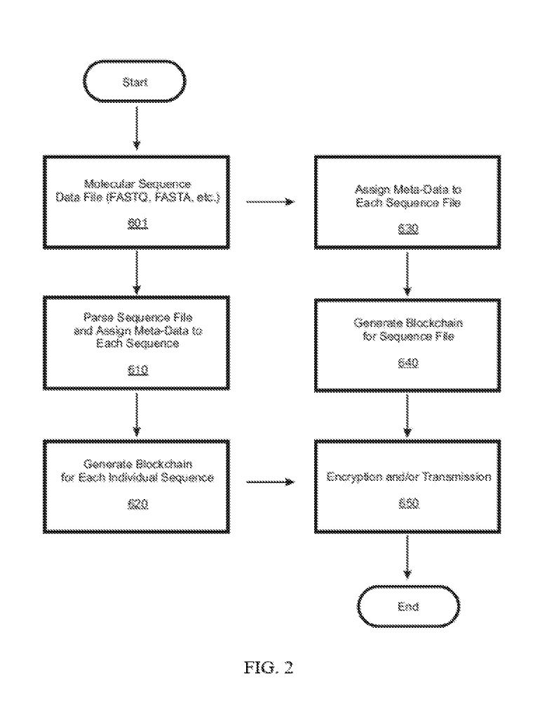

FIG. 2 illustrates the method by which the individual pieces of biomedical data, such as, for example, molecular sequences in a FASTQ, FASTA, or similar electronic storage format can be processed and assigned distributed cryptographic hash ledger indices. A sequence file (601) that stores DNA, RNA (ribonucleic acid), protein, or other molecular sequence data (or a file that stores multiple pieces of biomedical data) can be parsed using the software system and metadata generated/user entered for each sequence/piece of information (step 610), and then the source sequence data and associated metadata are used to generate a distributed cryptographic hash ledger for each individual molecular sequence or piece of biomedical data (step 620). In the case of molecular sequences such as DNA, the metadata may include information about coordinates, start positions, chromosome, molecular weight, gene designation, and other similar information. An optional atomic clock (or other time service) can be used to generate highly accurate time information which can be incorporated into the metadata, thereby providing hi resolution temporal information which is important during medical scenarios such as an outbreak, epidemic, or pandemic. Such information for the metadata may be provided via communication with, for example, an atomic clock, GPS-equipped devices, or such other devices, which optionally may also include a service certifying the accuracy of such metadata information. Then, the information can be optionally encrypted before transmission (step 650). Additionally, metadata can be assigned to the molecular sequence file (step 630), and then a distributed cryptographic hash ledger generated for the file and its metadata (step 640) before encryption and/or transmission (step 650) (further described below).

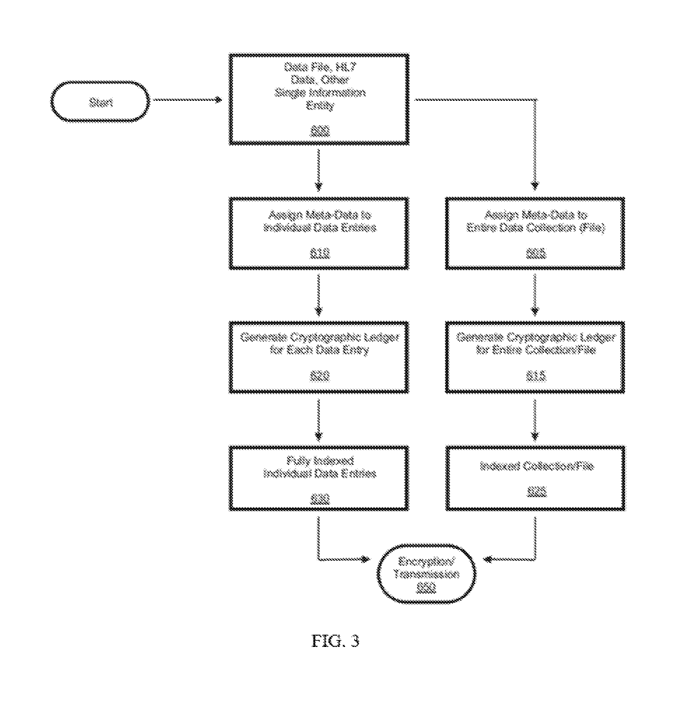

FIG. 3 illustrates the method of generating distributed cryptographic hash ledgers for medical information for individual pieces of biomedical information (such as a medical note, diagnostic test, lab result, etc.). Using discrete information which can include a data file (such as a text file with lab results, a record of vaccination or post-exposure prophylaxis such as during an outbreak), a timestamp or time information from an atomic clock/alternate time source, HL7 data that encodes clinical notes, medication administration, vaccination, post-exposure prophylaxis or similar information, or other piece of electronic information (600) can then be assigned metadata either through auto-generation or entered by the user (step 610). Additionally, metadata can be assigned to an entire collection of data (such as a computer data file stored in memory (step 605). Then, a distributed cryptographic hash ledger can be generated using the raw data and metadata for the data collection/file (615), or for each individual data entry (620), resulting in an indexed collection/file (625) and/or fully indexed data (630). The distributed cryptographic hash ledger data can be stored in the original sequence file (for example, by modifying the sequence descriptor with the distributed cryptographic hash ledger data) or by generating a new file format with the distributed cryptographic hash ledger data.

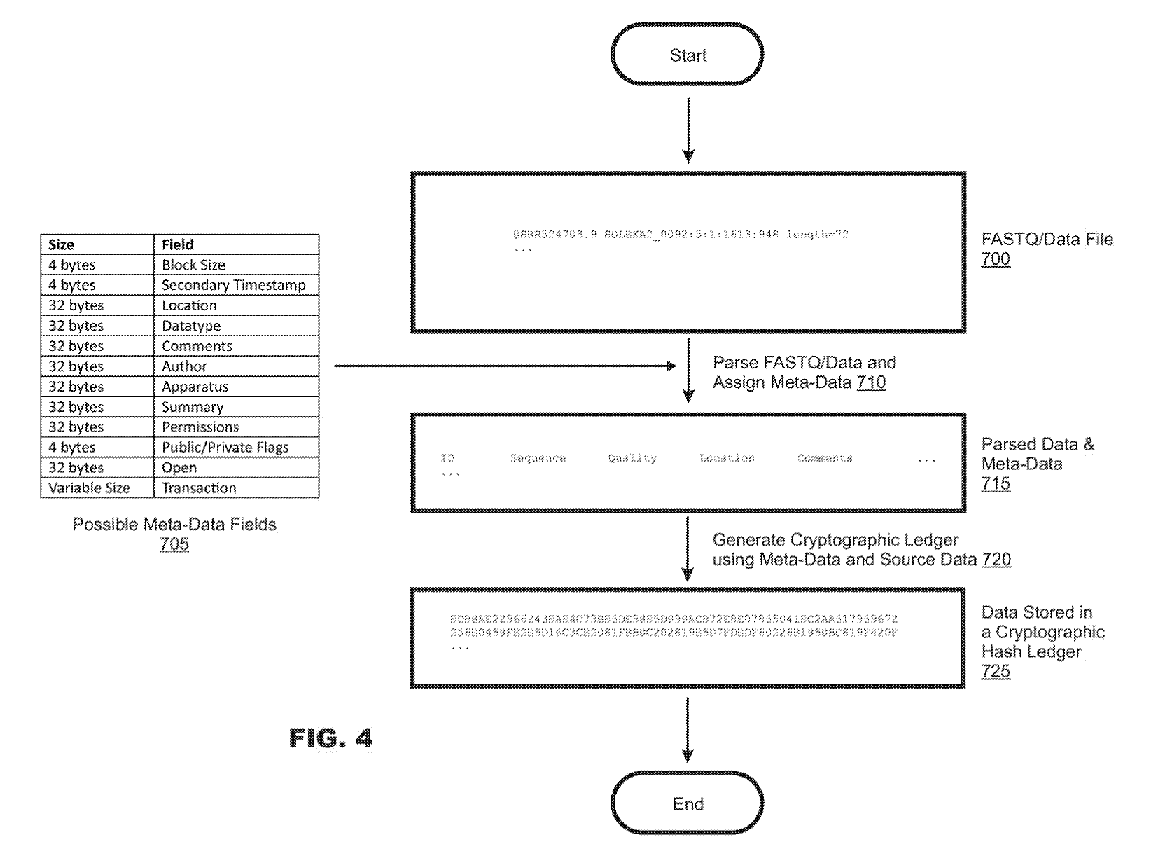

FIG. 4 illustrates the general method by which data (in this specific case, FASTQ data, 700) is parsed, metadata assigned therefor, and then distributed cryptographic hash ledgers generated for said data. Using discrete pieces of information in a collection/data file, a parser (which reads the FASTQ file/data file, and extracts sequence identifiers, sequence information, and other information) extracts the relevant data, and then generates metadata fields (such as those illustrated in 705) for each data entry (or in this case, FASTQ sequence; 710). The metadata can include auto-generated date/time, authorship, location, name of the patient, name of the apparatus, or other similar fields. Additionally, the metadata can include user-generated or user-set information, such as permissions which specify which computers or devices can accept the information being transmitted, comments, or similar information. Next, the source data and metadata (715) can be used to generate a distributed cryptographic hash ledger (720), resulting in fully indexed data (725).

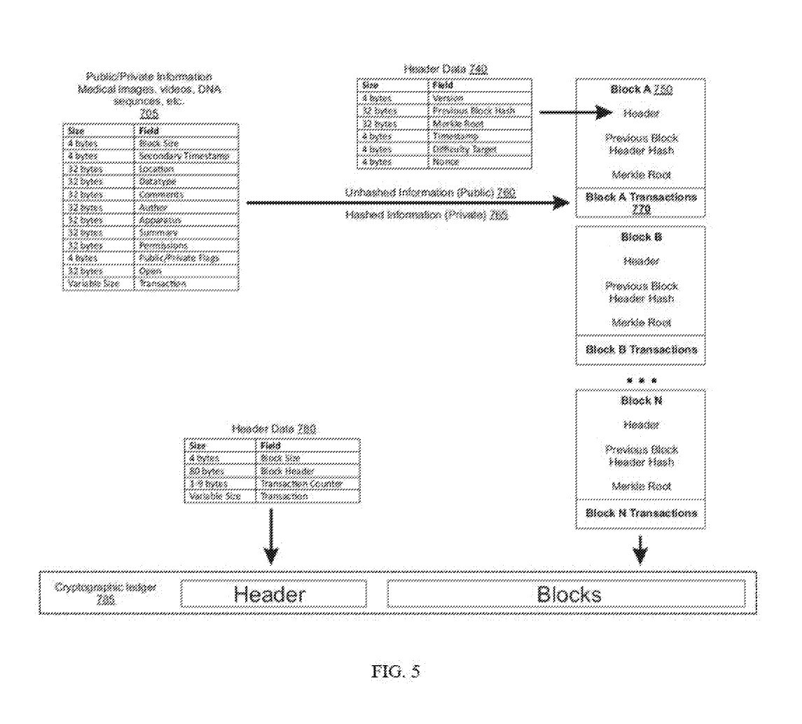

FIG. 5 describes the method of encoding the metadata into a distributed cryptographic hash ledger, such as a blockchain. Each block will contain metadata (740) stored in fields which are assigned to each block, along with transaction data. Various metadata fields (705) can remain unhashed for public information (760) or hashed for private information (765) and stored in each transaction block (770). General metadata for the cryptographic ledger/block chain is included in the header (780), which is then used to construct the entire cryptographic ledger (785).

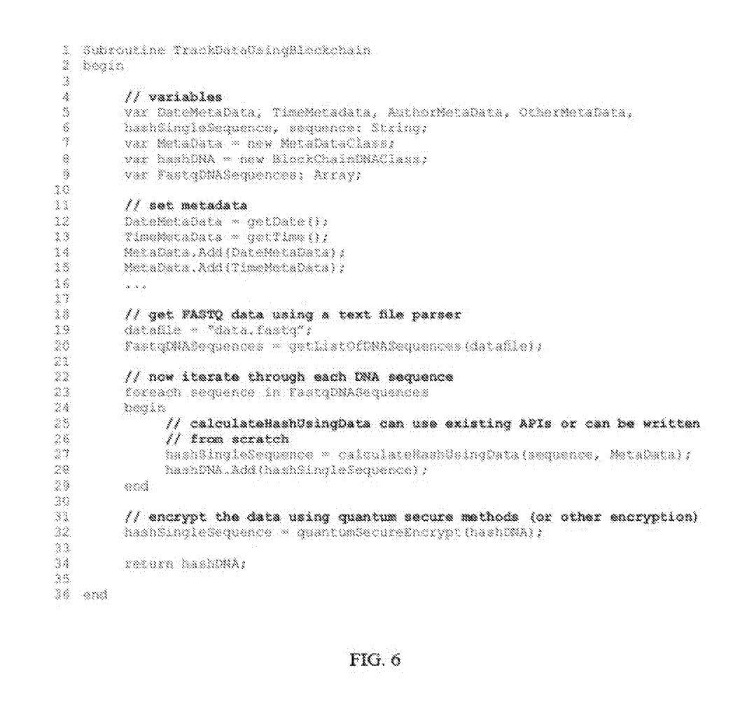

FIG. 6 illustrates an example of how the methods described in FIG. 4 and FIG. 5 might be implemented in software using pseudo-code. Metadata can be created using custom functions or built-in routines (lines 10-15). DNA or other molecular sequences can be extracted from a FASTQ file using a manually written text parser or existing FASTQ parser from a software library or framework such as BioJava (lines 18-20). Then, each sequence in the list of sequences extracted from the FASTQ file will have a blockchain/cryptographic hash ledger generated using the “calculateHashUsingData” function, which can draw upon existing software libraries or frameworks (such as BitCoinJ) or can be written from scratch, incorporating the approaches from FIG. 5. The whole list of sequences encoded in a cryptographic hash ledger is then produced (line 34). This method can be easily modified to produce a cryptographic hash ledger for a file rather than each piece of information in the file by using the filename as a single piece of information, and instead of iterating through each sequence (lines 22-29) just generating information for the filename, or substituting a modified version of line 27 for lines 22-29. The resulting information can then be encrypted using quantum-safe/quantum-secure approaches like quantum key distribution (line 31-32) or another method can be substituted for encryption, before storing the final resulting data in line 34.

Transmission (step 650, in FIGS. 2 and 3) involves sending the resulting information after cryptographic cypher generation, encryption, and storage to a specific address, or can be publicly broadcast to a variety of addresses. A private blockchain/cryptographic cypher can be broadcast to a specific address, and a public blockchain/cryptographic cypher can be broadcasted publicly over a network to a variety of targets without a specific address. Alternatively a private blockchain/cryptographic cypher can be broadcast publicly, or a public blockchain could be broadcast to a specific address. The destination address (which can be an IP address, URL, API information, or other formats of electronic addresses over a network, the Internet, etc.) is encoded directly into the ledger, and can also be stored in memory for transmission purposes. Transmission can also incorporate algorithms to make all of the transactions look similar, so that metadata cannot be inferred from transmissions, and used to predict the content (for instance, HIV data might be a certain size and transmitted at a particular time across a network). These measures can prevent the inference of data content even through the data is securely encrypted and made tamperproof using a cryptographic hash ledger. These precautions, in conjunction with the security provided by a cryptographic hash ledger, can help systems and institutions meet privacy requirements under regulations such as the Health Insurance Portability and Accountability Act (HIPPA) in the United States, and similar regulations in other jurisdictions.

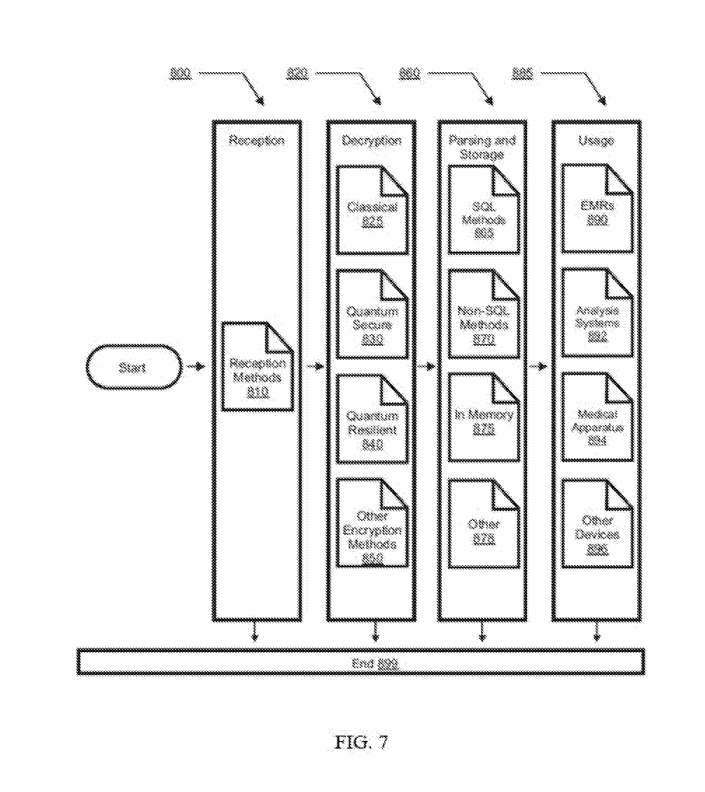

After transmission of the information and reception by a device, software, or other system, the data can then be just stored without processing it further, or it can also be optionally decrypted, parsed, stored, and used. Referring to FIG. 7, the transmitted data can be received using a number of different reception methods (810) in the reception layer (800), which can also have an address, such as a Bitcoin address. If necessary, the received data is then decrypted (820) using methods that correspond to the original encryption method(s) employed (i.e. classical (825), quantum-safe/quantum-secure (830), quantum resilient (840), or other methods (850)). Once decrypted, the information can then be stored (860) on the device using a relational database like SQL (865) or NOSQL (870), in memory (875), or another method (878). Once the information has been parsed and optionally stored, it can then be used (885) in different software systems such as electronic medical records (EMRs) (890), software analysis systems (892), medical devices (894), or other systems/devices (896). At any stage, the process can end (step 899).

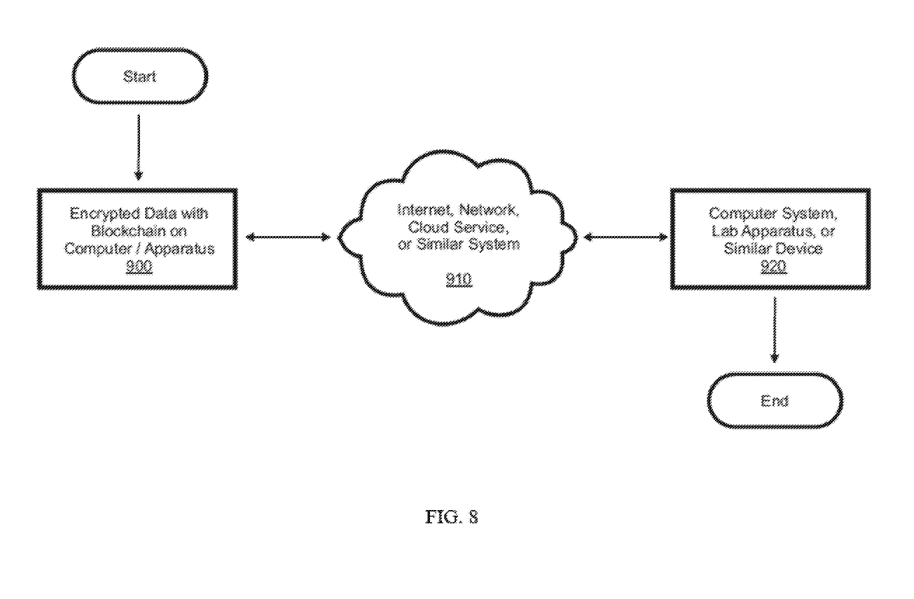

FIG. 8 illustrates how the biomedical data, metadata, and distributed cryptographic hash ledger indices can be transmitted from one device to another. The biomedical information (900), which optionally and preferably is encrypted, can be transmitted from a transmitting device to a receiving device (neither of which is specifically shown). The receiving device can potentially be directly connected to the existing or transmitting device, or connected by a variety of connections (910), such as through the Internet, direct network connections, wireless connections, or other means or via another device or devices. Once the information has been transmitted safely, with the distributed cryptographic hash ledger and optional encryption helping to make data tamperproof and secure the data, it can then be received by the receiving device (which may be a part of or connected to a computer system, laboratory apparatus or similar device) and decrypted (if required). Then the distributed cryptographic hash ledger information can be parsed to store the data in a local database or set of databases (920). It is also contemplated that transmission between the devices may use additional secure methods, such as secure sockets layer (SSL) or quantum-safe/quantum-secure communication.

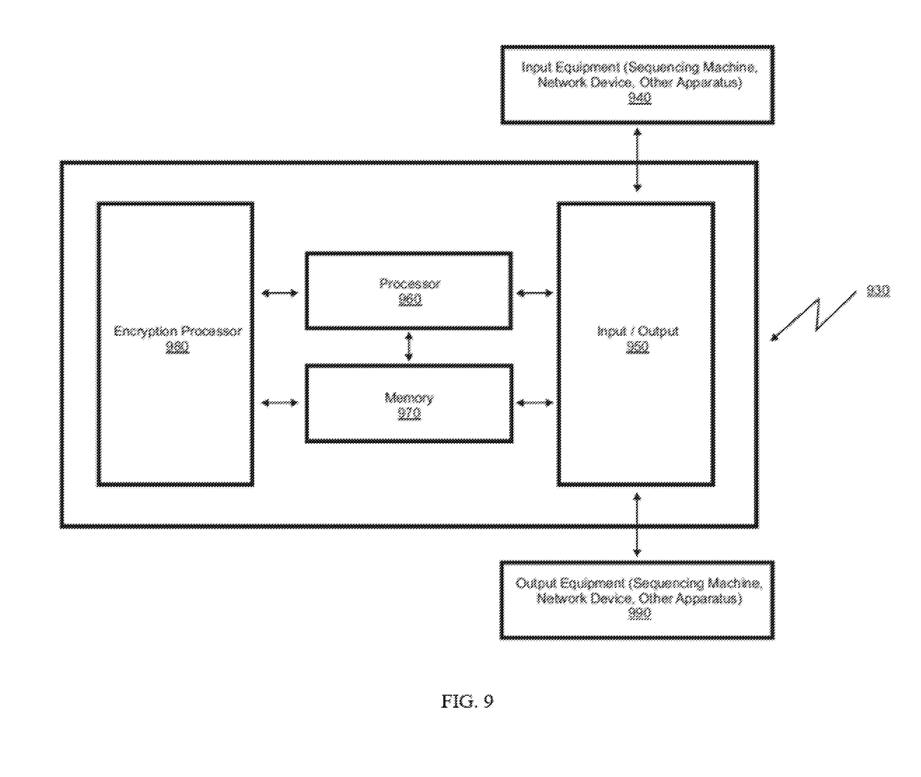

FIG. 9 illustrates a hardware implementation of the methods described above. A programmable processor and appropriate circuitry can be created (930), in which an input device, such as a sequencing machine or other computer with stored data (940) transmits data to the device using the input/output module (950). The data is then sent to the programmed processor, which performs the steps outlined in FIG. 1 while accessing memory (970). If required, an encryption processor can also be used to perform the encryption operations with the data (980). Once the data has been processed and indexed using distributed cryptographic hash ledgers, it is then transmitted to another device using the input/output module (950). Such a device could be used in a clinical setting for storing, analyzing, securing, and otherwise handling biomedical information, with appropriate FDA approval (or such other regulatory entities in other jurisdictions) when required.

In accordance with one aspect of the present invention, a computer-implemented method is disclosed for securely standardizing, anonymizing, transmitting, tracking, auditing, and ensuring the quality of biomedical information related to human beings and organisms to facilitate medical care, medical management, research, testing, managing an outbreak/epidemic/pandemic or similar activities centred around the use of tamper-proof tracking and auditing blockchain/related indexing methods and secure encryption such as quantum-secure/quantum-resilient encryption; the method comprising: a four layer implementation model, with the first layer/data layer consisting of the raw biomedical information to be transmitted, a second layer/metadata layer for generating associated metadata such as date, time, location, facility, author, and related fields; a third layer/indexing layer which consists of generating a blockchain or similar cryptographic/hashing method (such as SHA256, MD6, AES, etc.) to identify this information, and a fourth layer/encryption layer for optionally compressing and/or encrypting the data using a secure encryption method (such as Secure Socket Layer (SSL), quantum-secure methods, etc.). It is further contemplated that storing the data locally such as on a computer or electronic device co-located with the original location of the raw data, or transmitting the data usually with encryption to another computer system or electronic device over a network/link, and then decrypting the data if required, and then storing, analyzing, displaying the data or performing a similar activity while also storing the distributed cryptographic hash ledger, will facilitate auditing, quality control, and versioning of data. Further, key raw data and associated metadata respecting the information to be transmitted (including date, time, author, location, version, apparatus model, data type, standard codes (such as Systematized Nomenclature of Medicine (SNOMED) or International Classification of Diseases (ICD) codes), and similar information) may be included in the distributed cryptographic hash ledger. The information to be transmitted may be transmitted over a computer network from one or many computers or electronic devices to another computer/computers or multiple devices. The information may be received at a device, computer or computer network, where it can be decrypted, if necessary. It is further contemplated that the communication protocol that is used for transmitting the information may include one or more of: e-mail, Internet protocol (IP), transmission control protocol (TCP), Web Real-Time Communication (webRTC), file transfer protocol (FTP) or any other communications protocols.

In accordance with another aspect of the present invention, also disclosed is an optional programmable computer processor configured to implement the above described system entirely in customized hardware, thereby decreasing the likelihood of tampering with the process of generating metadata, the blockchain/distributed cryptographic hash ledger, and optionally compressing and encrypting information.

In accordance with another aspect of the present invention, the generated distributed cryptographic hash ledgers can either be public or private; the public distributed cryptographic hash ledger can be used for information storage, non-secure transmission to one or many recipients, and/or exchange beyond the current computer/electronic device, and private distributed cryptographic hash ledgers could be used for non-transmission purposes, transmission to a specific recipient, or other related uses, with different algorithms being used to generate each distributed cryptographic hash ledger. Furthermore, it is contemplated that the algorithm employed for generating the cryptographic index can link metadata to raw data and therefore facilitate the “anonymization” of large datasets (i.e. storing medical information so that the identifying information for particular patients is hidden/removed). This is normally achieved by storing identifying information and raw medical information in two separate datasets, with some sort of way of linking the identifying metadata to the medical data. However, this can result in cross-referencing errors, easy re-identification if the datasets are obtained by illegal means, etc. By linking data and metadata, and then obscuring the actual data and metadata behind the cryptographic hash and quantum-safe/quantum-secure or other encryption, the chance that information is lost through cross-referencing procedures, or that individuals can be easily re-identified from metadata or pieces of medical data is reduced. Additionally, the data that is used to generate the cryptographic hash ledger could be information that represents or encodes the link between particular sets of data or metadata, facilitating cross-referencing in a cryptographically secure, anonymized fashion. Further, the algorithm for generating the blockchain/distributed cryptographic hash ledger can use the raw data (or source biomedical information) and metadata, and can also include a device-specific counter or proprietary index for input with optional destination information in the form of geographical addresses, computer network addresses, or similar information. Further, the distributed cryptographic hash ledger may utilise an algorithm which factors in the raw data, metadata, the destination, and the public or private nature of the ledger.

In accordance with another aspect of the present invention, also disclosed is a computer-implemented method as described above, wherein the biomedical information can include: molecular sequence information such as DNA (deoxyribonucleic acid) sequence data in FASTQ format; protein sequence data, isoform or splice variant information, structural data such as data about chromatin conformation, microarray data, single nucleotide polymorphisms, or similar structural, sequence, or conformational data; or medical information such as electronic medical record information, laboratory tests, physician chart information and notes, annotations, and associated data, any and all of which may be in plain text, HL7 (Health Level 7), XML (eXtensible Markup Language) or other formats; or results from computational and bioinformatics analyses such as clustering or principal component analysis results, regression analysis parameters, statistical parameters such as p-values or confidence intervals, and related calculations.

1. A computer-implemented method to facilitate the recording and sharing of biomedical information, comprising:
a data layer processing step, wherein source biomedical information is acquired;
a metadata processing step, wherein metadata associated with the source biomedical information is generated;
a ledger generation step, wherein a cryptographic hashing method is applied to the source biomedical information and the associated metadata to index the information and generate a cryptographic hash ledger thereof;
a transmission step, wherein one or more of the source biomedical information, the associated metadata and the cryptographic hash ledger are transmitted to and received by a receiving device; and
a parsing and storage step, wherein the source biomedical information and the associated metadata are stored at the receiving device, in order for the source biomedical information and the associated metadata to be used or accessed when required.

2. The computer-implemented method of claim 1, additionally comprising:
prior to the transmission step, a data encryption step, wherein one or more of the source biomedical information, the associated metadata and the cryptographic hash ledger are encrypted into encrypted data using a secure encryption method prior to being transmitted; and
after the transmission step and prior to the parsing and storage step, a decryption step, wherein the encrypted data is decrypted using a decryption method corresponding to the secure encryption method used for the data encryption step.

3. The computer-implemented method of claim 2, wherein, in the data encryption step and in the decryption step, the secure encryption method is a quantum-safe, quantum-secure or quantum-resilient encryption method.

4. The computer-implemented method of claim 1, additionally comprising:
after the ledger generation step, a data storage step, wherein one or more of the source biomedical information, the associated metadata and the cryptographic hash ledger are stored either temporarily in volatile memory, or in a permanent storage device in order to facilitate tracking and auditing of the biomedical information.

5. The computer-implemented method of claim 1, wherein the cryptographic hash ledger is shared as a distributed cryptographic hash ledger.

6. The computer-implemented method of claim 1, wherein the biomedical information is one or more of: molecular sequence information; DNA (deoxyribonucleic acid) sequence data in FASTQ format; protein sequence data; isoform or splice variant information; structural data; sequence data; conformational data; structural data regarding chromatin conformation; microarray data; single nucleotide polymorphisms; medical information; electronic medical record information; laboratory tests; physician chart information and notes; annotations and associated data; results from computational and bioinformatics analyses; clustering or principal component analysis results; regression analysis parameters; statistical parameters; p-values and confidence intervals; any and all of which may be in plain text, HL7 (Health Level 7), or XML (eXtensible Markup Language) format.

7. The computer-implemented method of claim 1, wherein the metadata associated with the source biomedical information is a timestamp generated by an atomic clock.

8. A computer program product comprising a computer readable memory storing computer executable instructions thereon that when executed by a computer perform the steps of claim 1.
